(19) United States
(12) Patent Application Publication
(10) Pub. No.: US 2007/0260342 A1
(43) Pub. Date: Nov. 8, 2007

(54) Method for inspection process development or improvement and parts inspection process

(75) Inventors: Michael David McCormick, Winnipeg (CA); Kathryn Marie Atamanchuk, Winnipeg (CA); Michael J. Fields, Winnipeg (CA); Antonio Araujo Moura, Winnipeg (CA); Gilbert Edward Blanchette, Landmark (CA); John Andrew Rooney, Winnipeg (CA)

Correspondence Address: BIRCH STEWART KOLASCH & BIRCH, PO BOX 747, FALLS CHURCH, VA, 22040-0747, US

(73) Assignee: STANDARD AERO LIMITED

(21) Appl. No.: 11/429,229

(22) Filed: May 8, 2006

(51) Int. Cl. G06F 19/00

(52) U.S. Cl. 700/95; 702/185

(57) ABSTRACT

A method of developing or improving a parts inspection process, the method comprising: selecting at least one target part for inspection; convening a panel to review samples of the target part, and to define conditions and determine a disposition of the target part samples; conducting initial inspections of the target part samples to obtain sample inspection results; comparing the sample inspection results with the conditions and disposition of the target part samples set by the panel; determining a cause of variability between the sample inspection results and the conditions and disposition of the target part samples set by the panel and generating one or more solutions for the cause of variability; creating an inspection standard based on the one or more solutions; conducting training of inspectors using the inspection standard, with inspectors which qualify on the training proceeding with routine inspections; and conducting reviews of the routine inspections to determine an inspection error rate; wherein the routine inspections are allowed to continue if an acceptable inspection error rate is achieved, and wherein an inspection standard review is performed if an unacceptable inspection error rate is achieved.

### FIELD OF THE INVENTION

The present invention relates, generally, to inspection processes and methods of inspecting parts, goods or products. More specifically, the invention relates to a method for developing or improving an inspection process, such as a process for inspecting service-exposed engine components.

### BACKGROUND OF THE INVENTION

The economic downturn of the commercial airline sector over the last several years has forced airlines to reduce their operating costs, while at the same time defense budget constraints have placed significant pressure on the military to reduce support costs to maintain the operational capability and availability of their fleets. Accordingly, operators throughout the aerospace industry have been under increasing pressure to control maintenance costs.

For this reason, the assessment of service-exposed engine components has become increasingly more important for the industry as a means to control maintenance costs, including material and/or rework costs. Gas turbine engine parts are expensive to replace, and it is frequently more cost-effective to repair or refurbish a part rather than replace the part altogether. Inspectors involved in engine maintenance, repair, and overhaul (MRO) services need to determine whether a part should be replaced, or whether it can be refurbished and put back into use. In this way, the remaining service life of the engine parts can potentially be extended to reduce parts replacement costs.

Various parts inspection systems and problem tracking methods are known in the prior art. For instance, United States Patent Application Publication No. 2003/0101019 (Klausner et al.) discloses a method for determining the remaining serviceable life of a product, whereby values of certain performance quantities are acquired for a part and compared with a set of performance quality classes. The performance quality classes are qualified by value ranges for the individual performance quantities, and the service life is acquired as a function of the class in which the acquired value of the performance quantity falls.

Canadian Patent Application No. 2,400,366 (Vroman) discloses a computerized system for identifying repeatedly malfunctioning equipment, and the root causes therefor. According to this method, a database is provided comprising detailed equipment data, i.e. data indicative of historical equipment malfunctions. The equipment data includes a unique equipment identifier for uniquely relating each malfunction to respective equipment. The database is configured to automatically issue a report identifying any respective equipment as repeatedly-malfunctioning-equipment whenever the number of equipment malfunctions resulting in servicing activities exceeds a predefined equipment malfunction threshold.

Various other methods, such as the method of Butler et al. in U.S. Pat. No. 6,922,656, have been developed for identifying problem prone parts.

While these prior methods allow for the identification and tracking of problems associated with a part, none provides an effective means of controlling the inspection process, and thus inspector subjectivity and ensuing parts replacement rates can vary greatly. Accordingly, there is a need for a method of developing or improving an inspection process which facilitates greater inspection control, allowing for efficient monitoring and validation of part replacement and inspection error rates.

### SUMMARY OF THE INVENTION

An object of the invention is therefore to provide a method for developing or improving an inspection process with reduced inspection error and variation between inspectors.

As an aspect of the invention, there is provided a method of developing or improving a parts inspection process, the method comprising: selecting at least one target part for inspection; convening a panel to review samples of the target part and to define conditions and determine a disposition of the target part samples; conducting initial inspections of the target part samples to obtain sample inspection results; comparing the sample inspection results with the conditions and disposition of the target part samples set by the panel; determining a cause of variability between the sample inspection results and the conditions and disposition of the target part samples set by the panel and generating one or more solutions for the cause of variability; creating an inspection standard based on the one or more solutions; conducting training of inspectors using the inspection standard, with inspectors which qualify on the training proceeding with routine inspections; and conducting reviews of the routine inspections to determine an inspection error rate; wherein the routine inspections are allowed to continue if an acceptable inspection error rate is achieved, and wherein an inspection standard review is performed if an unacceptable inspection error rate is achieved.

The invention also provides, as a second aspect, a parts inspection process for determining whether a service-exposed part can be returned to service, the process comprising: selecting at least one target part for inspection; convening a panel to review samples of the target part, and to define conditions and determine a disposition of the target part samples; conducting initial inspections of the target part samples to obtain sample inspection results; comparing the sample inspection results with the conditions and disposition of the target part samples set by the panel; determining a cause of variability between the sample inspection results and the conditions and disposition of the target part samples set by the panel and generating one or more solutions for the cause of variability; creating an inspection standard based on the one or more solutions; conducting training of inspectors using the inspection standard, with inspectors which qualify on the training proceeding with routine inspections; and conducting reviews of the routine inspections to determine an inspection error rate; wherein the routine inspections are allowed to continue if an acceptable inspection error rate is achieved, and wherein an inspection standard review is performed if an unacceptable inspection error rate is achieved.

### BRIEF DESCRIPTION OF THE DRAWINGS

Examples of a preferred embodiment of the invention will now be described with reference to the accompanying drawings, in which:

FIG. 1 is a flow diagram illustrating an example of an inspection process development method according to the present invention,

FIG. 2 is a flow diagram illustrating an example of an inspection sampling plan for use in the inspection process development method according to the present invention, and

FIG. 3 is a flow diagram illustrating an example of a p-attribute control chart developed to monitor causes of variation according to the inspection process development method of the present invention.

### DETAILED DESCRIPTION OF THE INVENTION

The method of the present invention is particularly advantageous as a means of developing or improving a process for inspecting service-exposed parts. However, it is envisioned that the invention may be adapted to develop or improve any process for inspecting parts, components or other products requiring an assessment of serviceability or quality. For instance, the present method may alternatively be used to develop or improve inspection procedures for ensuring quality of production parts or other manufactured goods.

For exemplary purposes, the present invention will be further described with reference to the accompanying drawing as a method of improving or developing a process for inspecting service-exposed gas turbine engine parts during maintenance, repair, and/or overhaul (MRO) servicing.

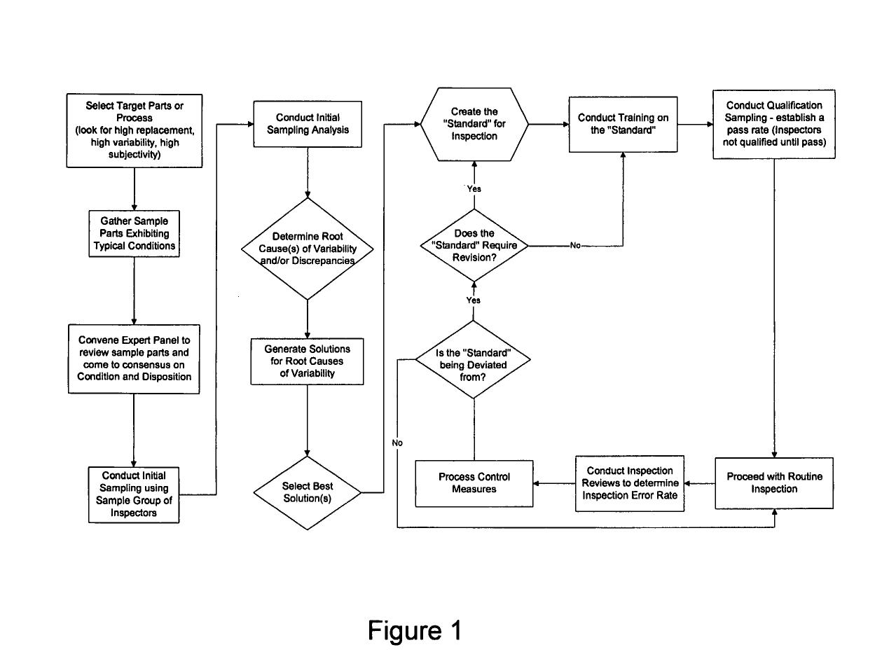

As illustrated in FIG. 1, the method begins with the selection of a target part or group of parts for inspection process improvement or development. The target parts will typically exhibit a high replacement rate, high variability in replacement rates between inspectors (an indication of subjectivity), and/or have a history of inspection issues. Inspection issues that can lead to a high variability in replacement rates between inspectors can include: unclear or contradictory inspection criteria; known conditions that are not covered in the inspection criteria, i.e., subjectivity in determining acceptability of a certain condition if there is no inspection criteria for the condition; as well as improper or inadequate tooling used to inspect a particular component.

Samples of the target parts exhibiting conditions that are typically found are gathered. Once the sample parts are selected, an Expert Panel is convened. The Expert Panel, which may comprise a group of senior inspectors, engineers or other parts experts, is responsible for inspecting the sample target parts and coming to a consensus on the conditions and final disposition thereof. The conditions present on the part may include any condition resulting from routine service life or otherwise, e.g., spalling, corrosion, denting, cracking (axial, circumferential, whisker type, indications), erosion, wear (fretting, galling, abrasive wear), delamination (peeling, flaking, blistering), scratching (scoring, nicks), micro-pitting/frosting, skidding, etc.. The final disposition of the part will, in the present example, typically be a determination of part serviceability or unserviceability.

In an alternate embodiment of the invention, such as the manufactured goods quality inspection process discussed above, the final determination may be a pass or fail result or other disposition based on the Expert Panel's assessment.

Next, an initial sampling is conducted using a sample group of inspectors. Each inspector is asked to individually inspect the sample target parts and record their assessment of the conditions and disposition. An analysis of the initial sampling results is then conducted, i.e. by comparing the initial sampling results to the Expert Panel results, to determine an Inspection Error Rate.

There are generally two types of Inspection Error, which are standard error-types in the industry. Type 1 Errors, which affect profitability, result when a serviceable part is unnecessarily rejected, or when an otherwise satisfactory part, product or batch of goods is deemed unsatisfactory. Type 2 Errors result when an unserviceable part is accepted, or when an unsatisfactory part, product or batch of goods is deemed satisfactory, thus negatively affecting quality.

Potential sources of Inspection Error are examined to determine root causes for the variability and/or discrepancies between the initial sampling results and the Expert Panel results. Corrective actions aimed at reducing Inspection Error are then generated and incorporated into an Inspection Standard. This will typically involve determining a set of possible solutions to alleviate the root causes of variability and/or discrepancy, with the best solutions selected for incorporation into the Inspection Standard.

A project owner or team of owners will preferably be assigned to one Inspection Process Improvement project. This person, or the individuals within the team, will typically be engineers, senior inspectors or other individuals familiar with the part. The project owner/team may then be responsible for overseeing the project, from selection of the target part (based on data) to the process control of the improved inspection method. In this embodiment, the project owner/team works in conjunction with the Expert Panel to analyze the sampling data and determine root causes and corrective actions. For instance, the project owner/team may conduct an analysis of the sampling results and hold sessions with inspectors and the Expert Panel to create cause-and-effect diagrams to help determine root causes and corrective actions.

The Inspection Standard may consist of documentation, training packages, and/or samples that clarify and supplement the existing technical data for the target part.

Training on the Inspection Standard is provided to all affected personnel, typically those involved in routine inspections. A qualification sampling is then conducted to assess the effectiveness of the training. A minimum pass rate is established and inspectors are not qualified to inspect production parts until they pass. Qualified inspectors may proceed with routine inspection.

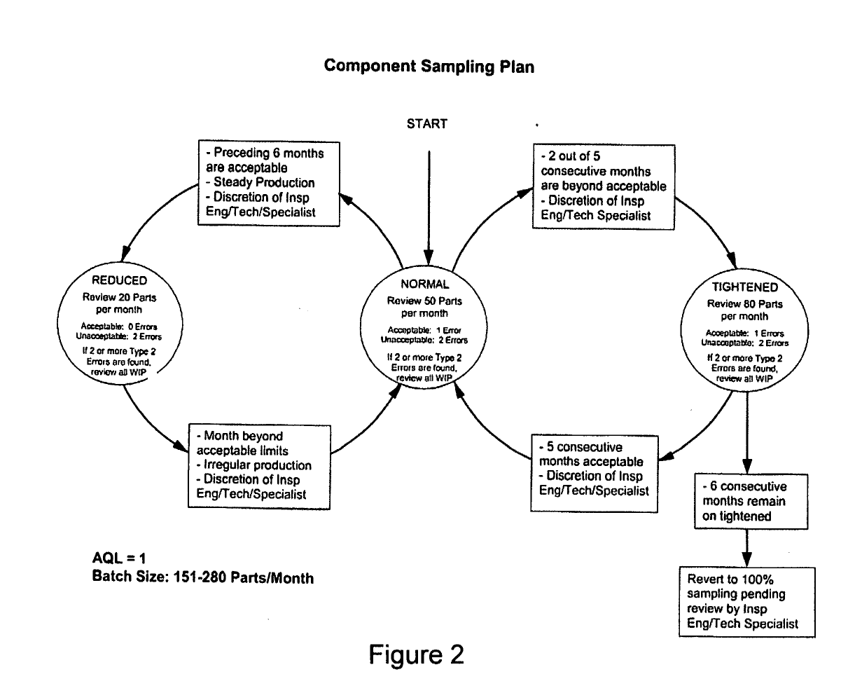

An Inspection Error Rate for the inspection results of those inspectors qualified on the Inspection Standard is then determined by conducting inspection reviews according to a statistical sampling plan. One example of a statistical sampling plan that may be used in combination with the present invention is described in Example 1, and illustrated in further detail in FIG. 2. In certain circumstances, it may be preferable for one or more members of the Expert Panel to conduct the inspection reviews as a means of verifying the inspection result.

Inspection process control measures such as the Inspection Error Rate and Replacement Rate (shown as a p-attribute control chart) are used to assess the effectiveness of the Standard.

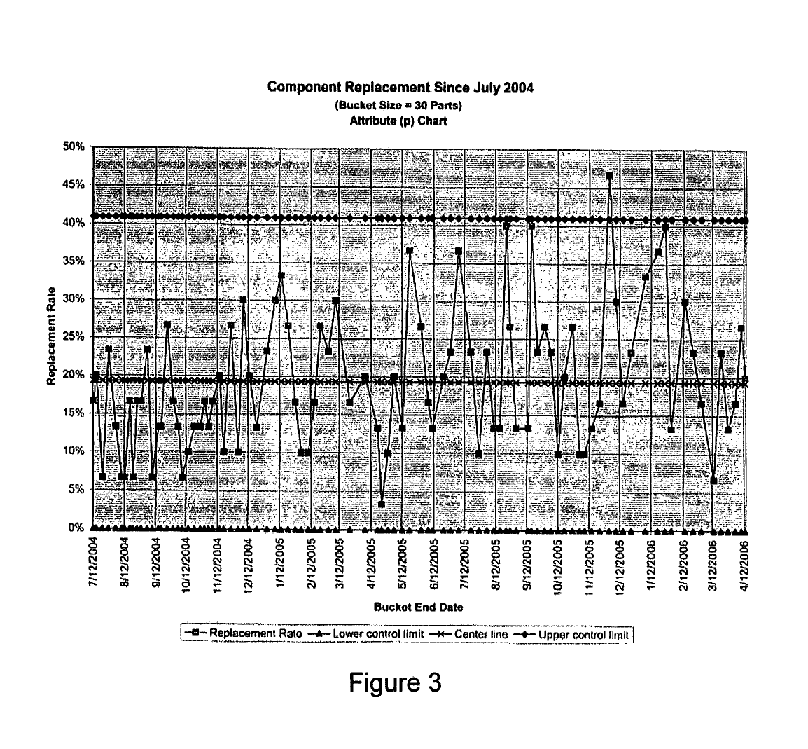

One possible example of a p-attribute control chart is given in FIG. 3. This chart allows the project owner/team to monitor the causes of variation in the replacement rate of a component. It is generated by plotting samples of replacement rate data and applying standard statistical equations to determine upper control limits (UCL) and lower control limits (LCL). If the replacement rate falls within the upper and lower control limits, the variation may be said to be due to ‘common causes’ of variation such as incoming unit condition (i.e. variations outside of the inspectors control). If the replacement rate points fall outside the upper and lower control limits, it signals ‘special causes’ of variation such as a new inspector, or deviation from the Inspection Standard. On the other hand, points outside the upper control limit may also simply indicate a very bad batch of parts. Accordingly, the points outside the upper control limit provide visibility of a potential problem that should be investigated.

If process control measures exceed set limits, further assessment is performed to determine the cause. This assessment may be conducted by the project owner/team, with input and advice obtained from the Expert Panel as necessary. If required, the Standard may be revised and/or additional training may be conducted. Alternatively, if the process control measures are within the set limits the inspections by qualified inspectors may be allowed to proceed, preferably with continued monitoring.

### EXAMPLE 1

Various statistical sampling plans may be developed for use with the present invention. In the present example, the statistical sampling plan was developed based on the principles contained in ANSI/ASQC Z1.4.1993-Sampling Procedures and Tables for Inspection by Attributes, which involves an inspection analysis whereby the product is classified as either conforming or non-conforming. Using the tables provided in the ANSI standard, a sampling plan was developed. The sampling plan was based on (a) an Acceptable Quality Level (AQL) of 1, where AQL equals the maximum percent nonconforming per 100 units that, for the purposes of the sampling inspection, can be considered satisfactory as a process average, and (b) a batch size of 151-180 parts, the average number of parts inspected in one month. A flow diagram of the sampling plan example is illustrated in FIG. 2.

As illustrated, the sampling starts under the ‘Normal’ category, whereby 50 parts out of the monthly batch are reviewed. Under this category, the occurrence of either one Type 1 or Type 2 Error is considered acceptable while the occurrence of two Type 1 or Type 2 Errors is considered unacceptable. All Work In Progress (WIP) is reviewed if two or more Type 2 Errors occur within the set time period, e.g. one month. If six consecutive months of inspections elapse with either Type 1 or Type 2 Errors within acceptable limits and steady production, the project owner/team may use their discretion and shift the inspection sampling to a “Reduced’ category. Under the ‘Reduced’ category, 20 parts out of the monthly batch are reviewed, no errors are acceptable, two errors are considered unacceptable, and all Work In Progress is reviewed if two or more Type 2 Errors occur within the time period. If a single month occurs outside of the acceptable limits and irregular production is observed, the project owner/team may use their discretion and return the inspection sampling to the ‘Normal’ category, e.g., if the acceptable number of errors has been exceeded, but the unacceptable number has not been reached (i.e. one error has been found), the lot may be accepted although Normal inspection is to be reinstated. On the other hand, if two out of five consecutive months of inspection sampling are determined to be beyond the acceptable limits, the project owner/team may use their discretion and move the inspection sampling to a ‘Tightened’ category. Under the ‘Tightened’ category, 80 parts out of the monthly batch are reviewed, the occurrence of one error is considered to be within acceptable limits, the occurrence of two errors is considered unacceptable, and all Work In Progress is reviewed if two or more Type 2 Errors are found. If a period of five consecutive months is achieved within the acceptable limits, the project owner/team may use their discretion and move the inspection sampling back to the ‘Normal’ category. On the other hand, if the inspection sampling continues for six consecutive months under the ‘Tightened’ category, the project owner/team may revert to sampling all of the parts out of the monthly batch.

The above-described invention provides for the development of a controllable inspection process with effective inspection standards and standardized training of personnel based on the inspection standards. The resulting inspection process generally yields greater inspection consistency, thereby potentially reducing the overall cost of the maintenance, repair, and/or overhaul (MRO) servicing and improving the quality of the serviced product.

All patents and patent applications mentioned in this specification are indicative of the level of skill of those skilled in the art to which this invention pertains, and are herein incorporated by reference to the same extent as if each individual publication or patent application was specifically and individually indicated to be incorporated by reference.

I claim:

1. A method of developing or improving a parts inspection process, said method comprising the steps of:
(a) selecting at least one target part for inspection;
(b) convening a panel to review samples of said target part, and to define conditions and determine a disposition of said target part samples;
(c) conducting initial inspections of said target part samples to obtain sample inspection results;
(d) comparing said sample inspection results with the conditions and disposition of said target part samples set by the panel;
(e) determining a cause of variability between the sample inspection results and the conditions and disposition of said target part samples set by the panel and generating one or more solutions for said cause of variability;
(f) creating an inspection standard based on the one or more solutions;
(g) conducting training of inspectors using said inspection standard, with inspectors which qualify on said training proceeding with routine inspections; and
(h) conducting reviews of said routine inspections to determine an inspection error rate;
wherein the routine inspections are allowed to continue if an acceptable inspection error rate is achieved, and wherein an inspection standard review is performed if an unacceptable inspection error rate is achieved.

2. The method of developing or improving a parts inspection process according to claim 1, wherein the panel is a panel of one or more experts in the field of the target part.

3. The method of developing or improving a parts inspection process according to claim 1, wherein the initial inspections are conducted by a sample group of inspectors.

4. The method of developing or improving a parts inspection process according to claim 1, wherein said inspection standard comprises documentation, training packages, and/or samples that clarify and supplement existing technical data for the target part.

5. The method of developing or improving a parts inspection process according to claim 1, wherein said inspection standard is based on a selection of the best solutions generated in step (e).

6. The method of developing or improving a parts inspection process according to claim 1, wherein a pass rate is established for the qualification of said inspectors in step (g), and said inspectors do not qualify to proceed with said routine inspections until they meet or exceed said pass rate.

7. The method of developing or improving a parts inspection process according to claim 1, wherein said reviews of the routine inspections are conducted by said panel.

8. The method of developing or improving a parts inspection process according to claim 1, wherein said inspection error rate is compared with statistical measures to determine whether said inspection error rate is acceptable or unacceptable.

9. The method of developing or improving a parts inspection process according to claim 8, wherein said statistical measures comprise a p-attribute control chart.

10. The method of developing or improving a parts inspection process according to claim 1, wherein said inspection standard review comprises a determination of whether the inspection standard requires revision.

11. The method of developing or improving a parts inspection process according to claim 10, wherein steps (g) and (h) are repeated if said inspection standard is determined to be satisfactory without revision.

12. The method of developing or improving a parts inspection process according to claim 10, wherein said inspection standard is revised and steps (g) and (h) are repeated if said inspection standard is determined to require revision.

13. The method of developing or improving a parts inspection process according to claim 1, wherein if said acceptable inspection error rate is achieved the routine inspections are allowed to continue with step (h) repeated to ensure that said acceptable inspection error rate is maintained.

14. The method of developing or improving a parts inspection process according to claim 1, wherein said part is a service-exposed gas turbine engine part.

15. A parts inspection process for determining for determining whether a service-exposed part can be returned to service, said process comprising the steps of:
(a) selecting at least one target part for inspection;
(b) convening a panel to review samples of said target part, and to define conditions and determine a disposition of said target part samples;
(c) conducting initial inspections of said target part samples to obtain sample inspection results;
(d) comparing said sample inspection results with the conditions and disposition of said target part samples set by the panel;
(e) determining a cause of variability between the sample inspection results and the conditions and disposition of said target part samples set by the panel and generating one or more solutions for said cause of variability;
(f) creating an inspection standard based on the one or more solutions;
(g) conducting training of inspectors using said inspection standard, with inspectors which qualify on said training proceeding with routine inspections; and
(h) conducting reviews of said routine inspections to determine an inspection error rate;
wherein the routine inspections are allowed to continue if an acceptable inspection error rate is achieved, and wherein an inspection standard review is performed if an unacceptable inspection error rate is achieved.

16. The parts inspection process according to claim 15, wherein the panel is a panel of one or more experts in the field of the target part.

17. The parts inspection process according to claim 15, wherein the initial inspections are conducted by a sample group of inspectors.

18. The parts inspection process according to claim 15, wherein said inspection standard comprises documentation, training packages, and/or samples that clarify and supplement existing technical data for the target part.

19. The parts inspection process according to claim 15, wherein said inspection standard is based on a selection of the best solutions generated in step (e).

20. The parts inspection process according to claim 15, wherein a pass rate is established for the qualification of said inspectors in step (g), and said inspectors do not qualify to proceed with said routine inspections until they meet or exceed said pass rate.

21. The parts inspection process according to claim 15, wherein said reviews of the routine inspections are conducted by said panel.

22. The parts inspection process according to claim 15, wherein said inspection error rate is compared with statistical measures to determine whether said inspection error rate is acceptable or unacceptable.

23. The parts inspection process according to claim 22, wherein said statistical measures comprise a p-attribute control chart.

24. The parts inspection process according to claim 15, wherein said inspection standard review comprises a determination of whether the inspection standard requires revision.

25. The parts inspection process according to claim 24, wherein steps (g) and (h) are repeated if said inspection standard is determined to be satisfactory without revision.

26. The parts inspection process according to claim 24, wherein said inspection standard is revised and steps (g) and (h) are repeated if said inspection standard is determined to require revision.

27. The parts inspection process according to claim 15, wherein if said acceptable inspection error rate is achieved the routine inspections are allowed to continue with step (h) repeated to ensure that said acceptable inspection error rate is maintained.
